(19) United States
(12) Patent Application Publication
(10) Pub. No.: US 2013/0062481 A1
(43) Pub. Date: Mar. 14, 2013

(54) Railing mounting system

(71) Applicant: John Christopher Petrakis, Ashburn, VA (US)

(72) Inventor: John Christopher Petrakis, Ashburn, VA (US)

(21) Appl. No.: 13/573,417

(22) Filed: Sep. 14, 2012

Related U.S. Application Data
(60) Provisional application No. 61/573,145, filed on Sep. 14, 2011.

(51) Int. Cl. F16M 13/02

(52) U.S. Cl. 248/205.1

(57) ABSTRACT

A railing mounting system for use on decks, balconies, fences or patios to provide additional surface space. In addition, the frame can be used to contain plantings, herb gardens, coolers, grills or other outdoor items. The mounting system is quickly and easily installed for use and just as easily removed and stored for subsequent use.

This application claims priority to U.S. provisional patent application 61/573145 filed Sep. 14, 2011.

### BACKGROUND

1. Technical Field

The present disclosure relates generally to a railing extension device for supporting various articles, and more specifically to a device that mounts to a railing and can support various items, including but not limited to a beverage cooler, trash can, a cooler, an electric grill, a glass surface for containing serving dishes and glasses, plants and/or an herb garden.

2. Description of Related Art

Decks, balconies and patios are prevalent in homes and restaurants and often contain a railing system of sorts to assist in providing a safety measure and barrier for occupants as decks, balconies and patios are often above ground level and/or may be near hazards such as water. Most decks, balconies and patios contain tables and chairs in order to provide places for people to eat and put their beverage glasses. The addition of tables and chairs often limits the amount of space available for people to stand and/or walk around on. Due to this, occupants often place plates and glasses on railings. These can easily be knocked off or slide off as the surface of the railing is not even due to warping or in the case of balconies the railing may only be one inch wide and therefore not useable for holding items.

To meet the problem of providing additional surface space for decks and patios, a frame and strap system has been developed which can quickly attach to any shape or size railing and may extend outward away from and/or inward on the deck, balcony or patio. The frame can be made of various durable materials, including but not limited to wood (including teak), aluminum, wrought iron, stainless steel, titanium, or a polymer/plastic material. The device has a rectangular frame shape, but could be square, circular, triangular or any polygonal shape if desired. In addition, the device can have one or more points of contact between the railing and the proximal portion of the frame for attachment of the device. One benefit of the device is its ability to adjust and attach to various shaped railings and various sized railings. The device also contains another member which is an additional point of contact from the frame to the floor/base of the deck, balcony or patio. This member is angled from the most external/distal portion of the frame to the base/floor. This member can be telescoping and can be attached to the frame via a hinge in order to allow for it to fold up and minimize space of the device when not in use. This member or leg could also occur on both sides of the device, with the second member/leg contacting the bottom horizontal brace of the railing or balcony.

Therefore, a need exists for a lightweight device that can quickly, easily and releasably attach to a railing, fence or the like, to provide additional surface area and/or additional display area for occupants to place various items including but not limited to food items or glasses.

### SUMMARY

The present disclosure is directed to a railing extension device which provides a support frame that releasably attaches to a railing. The device can quickly and easily be attached to a railing or fence and then when it is no longer in use it can just as quickly and easily be removed and stored. The preferred embodiment of the device contains two brackets that mount to the proximal portion of the support frame (hereinafter frame). These brackets are permanently attached to the frame and contain an L shaped protrusion which accommodates a strap or cable member. The L shaped bracket could be replaced with various other well known means for holding the strap or cable in place and work just as efficiently. The strap or cable can be made from a variety of materials, including but not limited to nylon, rubber (synthetic or natural) or stainless steel. The strap member continues through a cinching buckle and can be tightened accordingly to maintain the position of the frame. The cinching buckle could also be replaced with other well known means for holding tension on a cable or strap and work just as well. Other types of tightening mechanisms can be used to tighten and secure the strap to the desired tension, including but not limited to a wench type mechanism, a rack and pinion type mechanism, or a spring loaded clamp mechanism. The strap from the buckle is attached at its other end to a U-shaped bracket. The U shaped bracket is moveable and can be of various lengths, widths and sizes and resides sandwiched between the frame and the railing. This allows the weight of whatever is put on top of the frame to further anchor the device to the railing. The U shaped bracket is uniquely locked in place by the use of a detent pin that is inserted through a slot in the side of the U shaped bracket and traverses across the entire width of the U shaped bracket and out a slot on the opposite side of the U shaped bracket. The pin resides in the slots and keeps the U shaped bracket locked in place. Lastly, the distal portion of the frame has a telescoping member or leg that is pivotally attached to the frame. Once extended, the leg contacts the surface of the deck, balcony or patio to provide additional support for the frame.

In another embodiment the device could contain drop in compartments for various items, including but not limited to a cutting board and utensils. It is also contemplated that the device could be adapted for marine applications as well as tailgating applications or with fences that have a horizontal cross member.

### BRIEF DESCRIPTION OF THE DRAWINGS

The above and other aspects and features of the present disclosure will become more apparent in light of the following detailed description when taken in conjunction with the accompanying drawings in which:

FIG. 1 is an exploded assembly view of the Deckmate device

FIG. 2 is an isometric view of the Deckmate device

FIG. 3 is an exploded view of the telescoping leg assembly

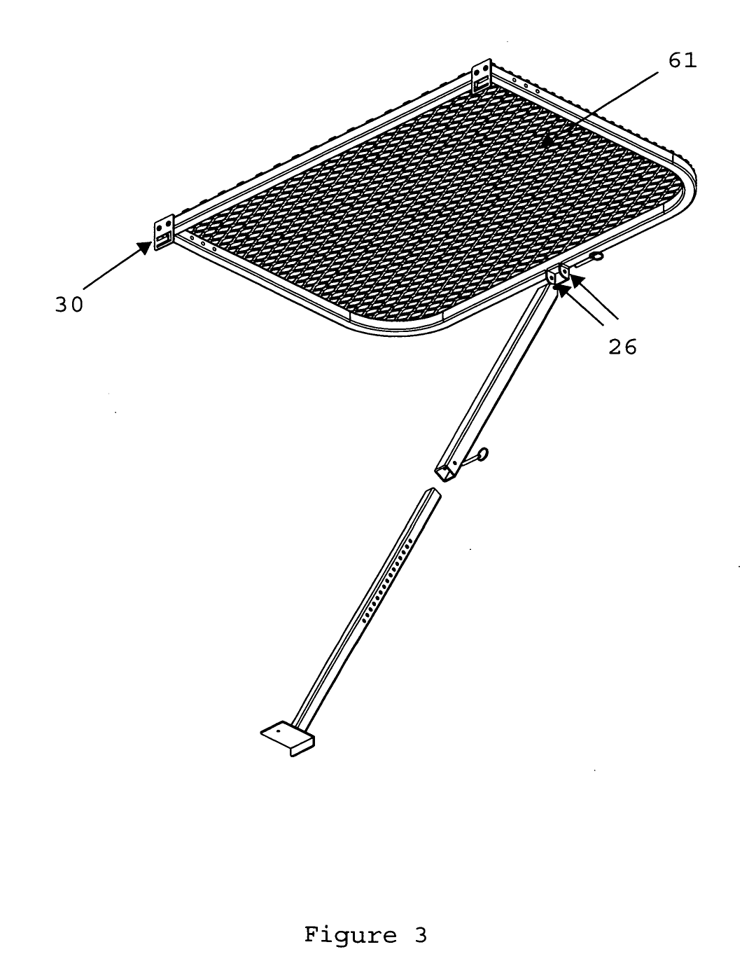

FIG. 4 is a close up view of the strap and buckle assembly

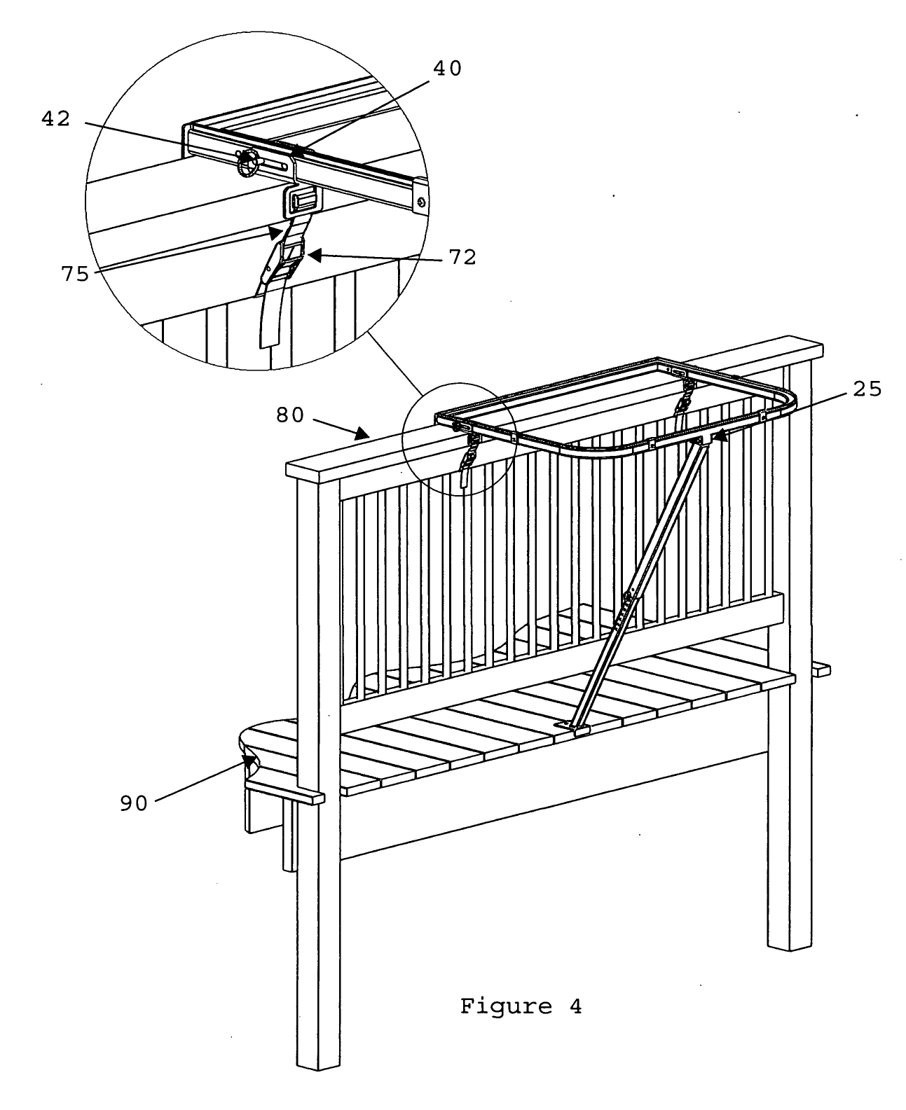

FIG. 5A is a close up view of the L bracket assembly, the Deckmate device facing outward from the railing

FIG. 5B is a close up view of the Deckmate device attached to the railing and facing inward from the railing

FIG. 6 is a close up view of the Deckmate in use holding a cooler

FIG. 7 is a second close up view of the Deckmate in use holding a cooler

FIG. 8 is a close up view of the Deckmate spanning space inside and outside the railing

FIG. 9 is an isometric view of the frame

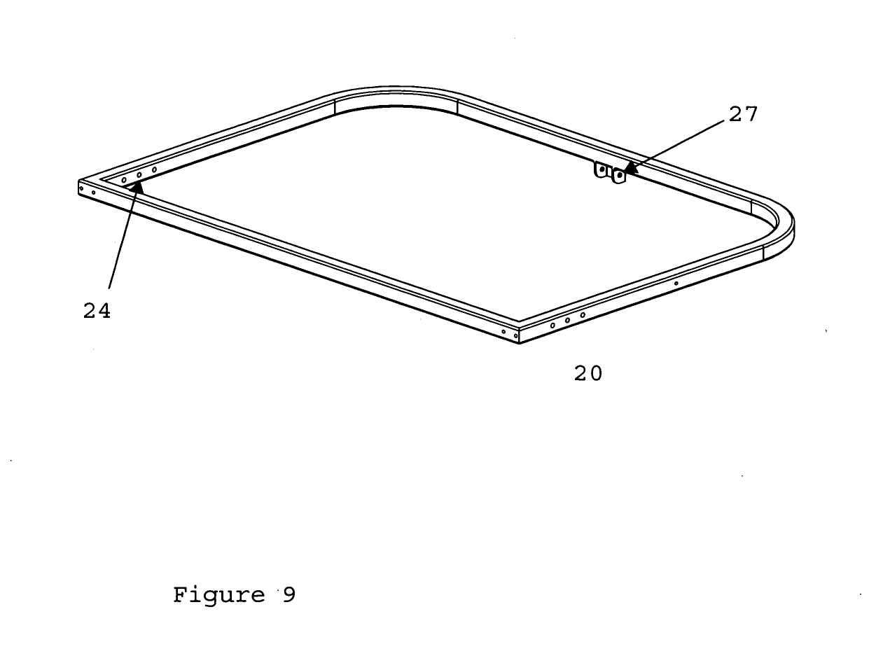

FIG. 10 is an isometric view of the glass insert for the frame

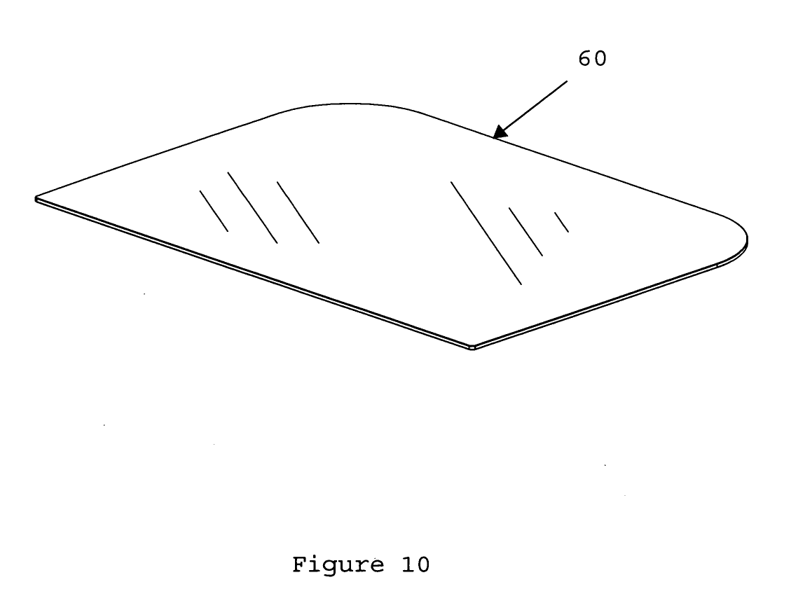

FIG. 11 is a bottom view of the frame with a mesh top insert

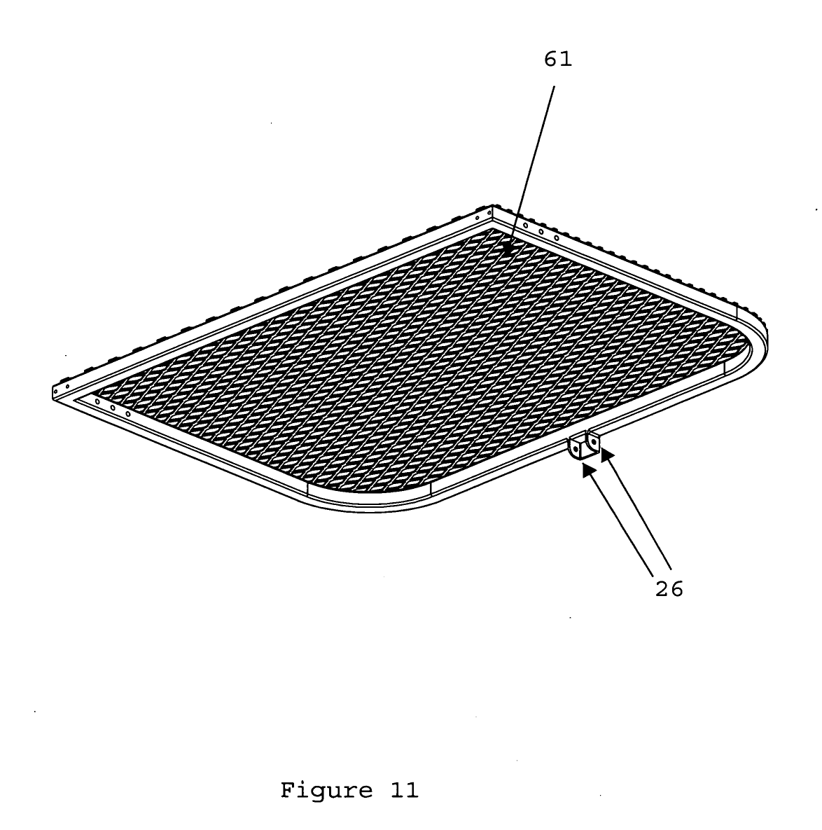

FIG. 12 is an isometric view of the L bracket

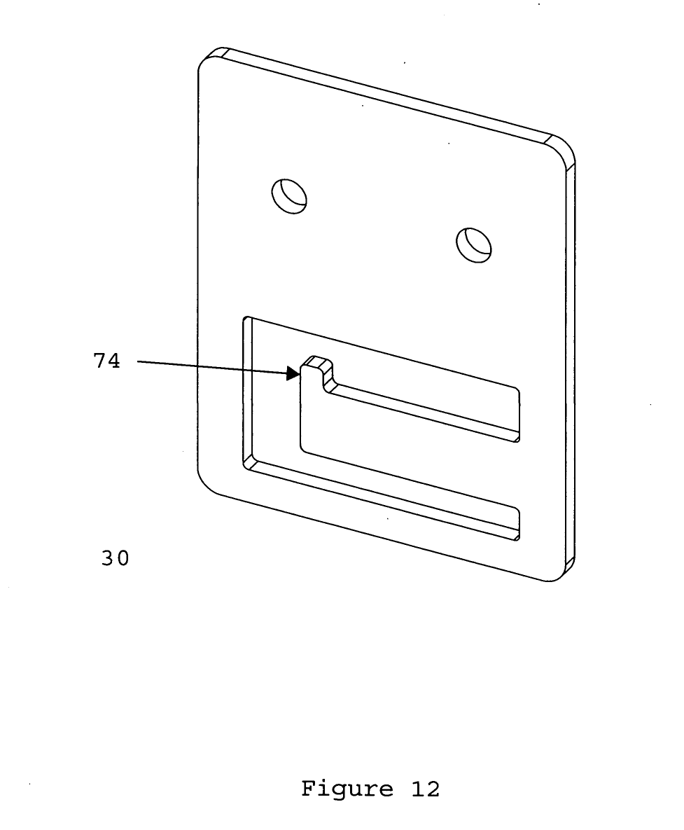

FIG. 13 is an isometric view of the U bracket

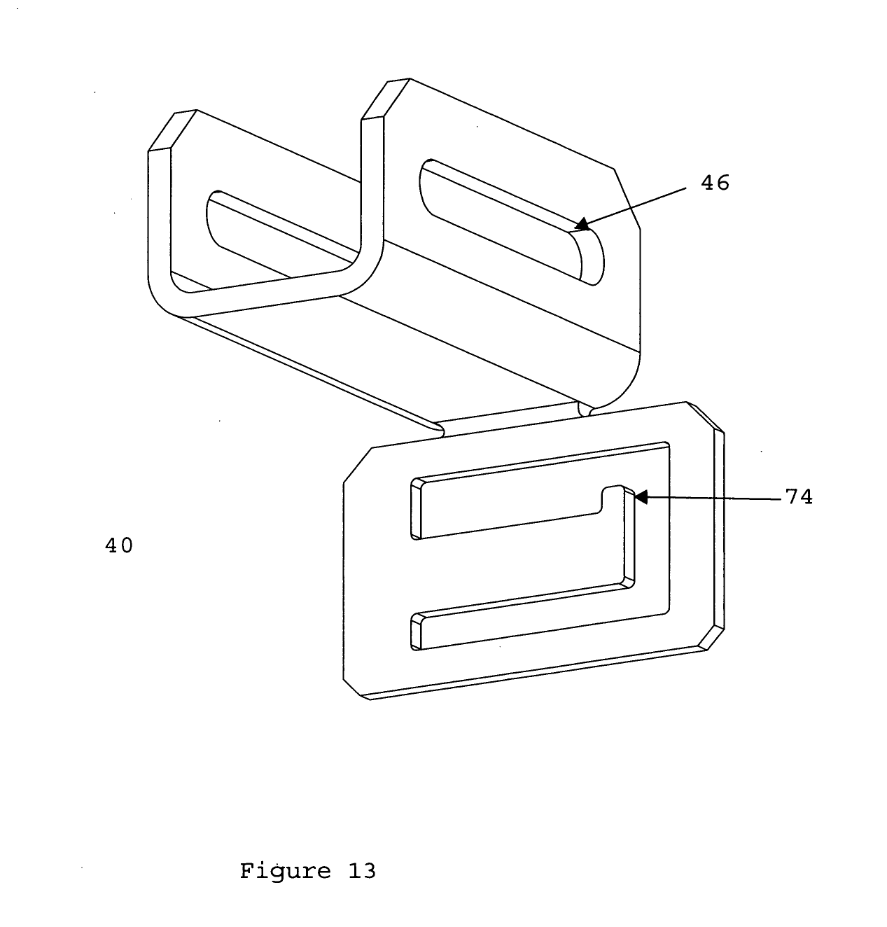

FIG. 14 is an isometric view of the tabs that support the glass insert with the frame

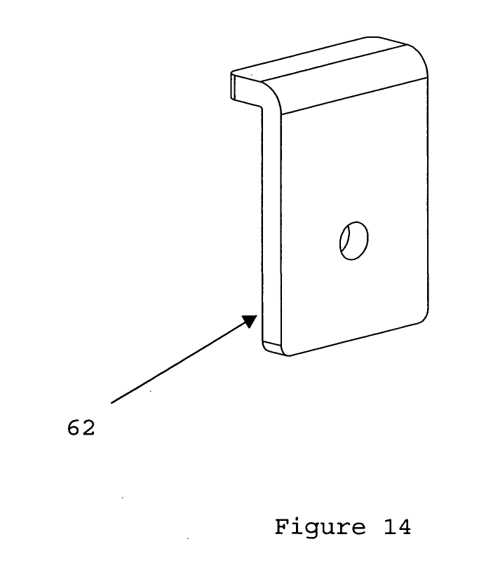

FIG. 15 is an isometric view of the top portion of the telescoping leg

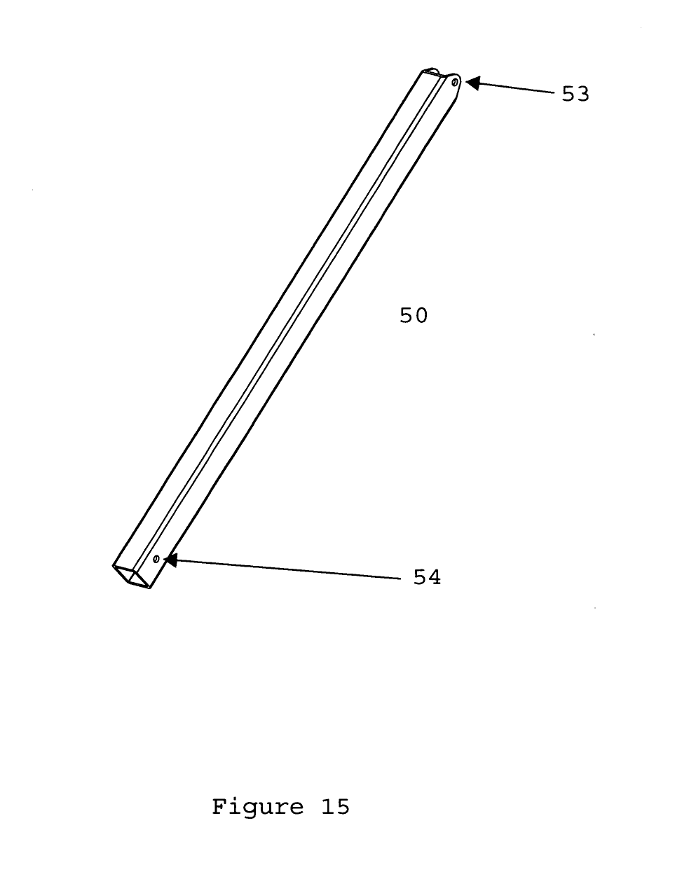

FIG. 16 is an isometric view of the bottom portion of the telescoping leg

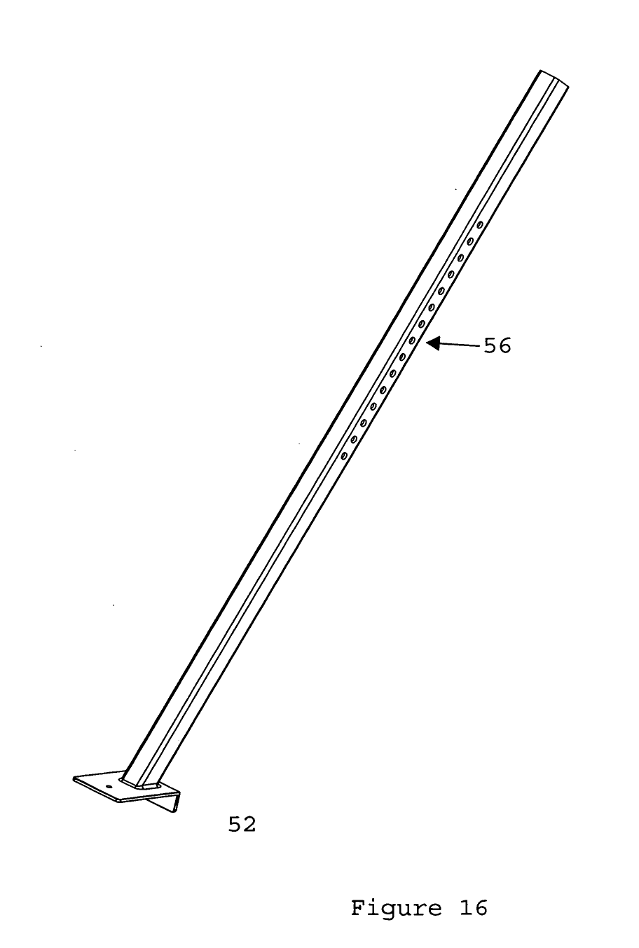

### DETAILED DESCRIPTION OF THE EMBODIMENTS

Particular embodiments of the present disclosure will be described herein with reference to the accompanying drawings. As shown in the drawings and as described throughout the following description, and as is traditional when referring to relative positioning on an object, the terms “proximal” and “trailing” may be employed interchangeably, and should be understood as referring to the portion of a structure that is closer to a user during proper use. The terms “distal” and “leading” may also be employed interchangeably, and should be understood as referring to the portion of a structure that is farther from the user during proper use.

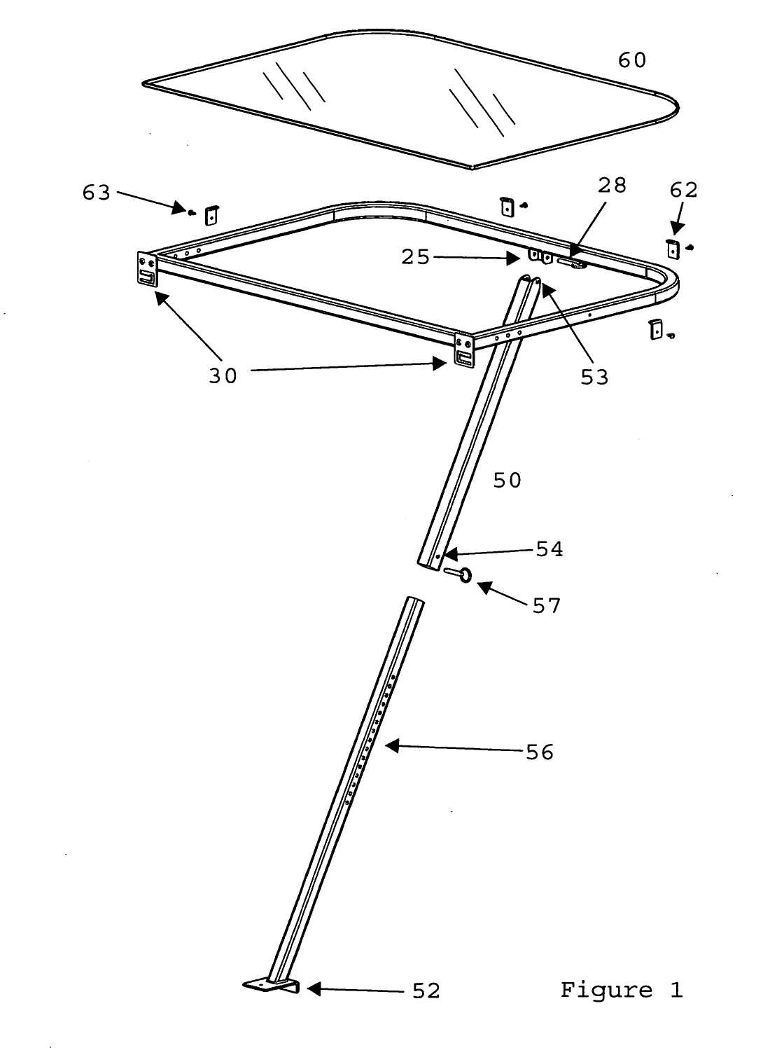

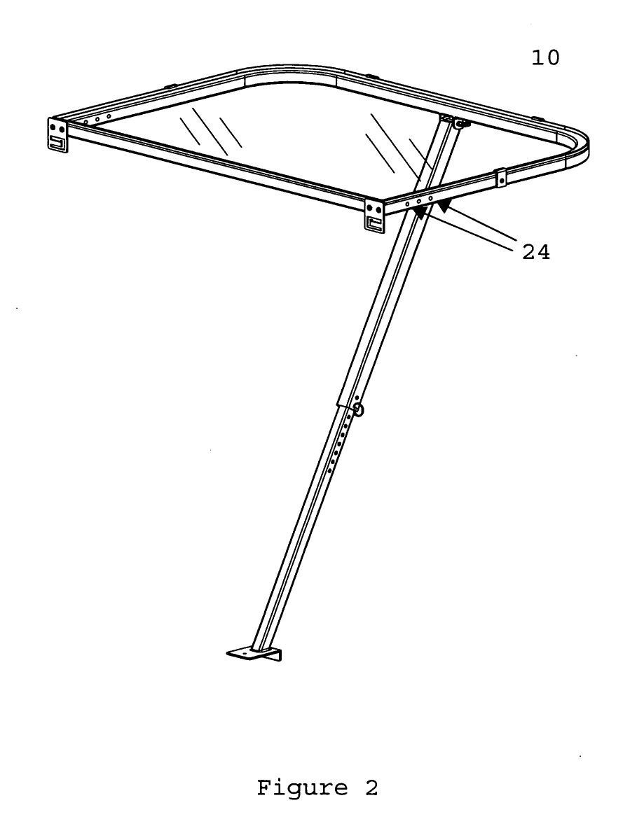

Referring initially to FIGS. 1 and 2, the rail mounting system 10 consists of a frame 20. The frame 20 can be various shapes, but is D-shaped in the preferred embodiment. In the preferred embodiment there are two brackets with an L shaped feature, herein after called the L brackets 30 which are permanently mounted to the proximal portion of the frame 20 with the use of Phillips head screws, but could also be mounted with various well known techniques including but not limited to riveting and welding. The L brackets 30 utilize this L shaped member to contain the strapping 70 and use the vertical portion 74 of the L shape to prevent it from sliding off the L bracket 30. The strapping 70 continues and connects to a cinching type buckle 72 that can be tightened accordingly to maintain the position of the frame. The buckle 72 has a second piece of strapping 75 that connects to a U shaped bracket 40. Preferably, two U shaped brackets 40 are used and they are placed between the railing 80 and the frame 20, thus looping the strapping 70 and 75 around the railing 80. The U shaped bracket 40 contains a slot 46 on either side to accommodate detent pin 42 which is used to attach the U shaped bracket 40 to the frame 20. As noted in FIG. 2, the frame 20 has adjustment holes 24 to accommodate various placement locations of the U shaped bracket 40. Once the U shaped bracket 40 is in place, the strapping 70, 75 can be tightened to secure the frame 20 to the railing 80. The placement of the U shaped bracket 40 under the frame 20 and on top of the railing 80 serves a unique purpose in that it allows for the weight that is placed on the frame 20 to further secure the frame 20 in place.

The frame 20 also contains a post feature 25 on its distal side. The post feature 25 comprises two upright members 26 which have a through hole 27 for detent pin 28 to reside. The post 25 mates with a telescoping leg 50, whereby its proximal end also contains a through hole 53 to mate with detent pin 28. The telescoping leg 50 contains adjustment holes 56 along its length to accommodate various heights between railing 80 and floor 90. The adjustment holes 56 utilize detent pin 57 and through hole 54 on the upper leg portion to lock the telescoping leg 50 into place. The telescoping leg 50 also has a foot 52 which rests on the floor surface 90. The foot 52 consists of an L shape rigid member that rests on both the top and side surface of the floor 90. The foot 52 may also be screwed into place into the floor surface to prevent any movement of the telescoping leg 50. It is also contemplated that this foot 52 could be angularly adjustable to accommodate various unevenness that may occur with floor surfaces 90. The telescoping leg 50 provides additional support for the railing mounting system 10, much like a tripod would by providing a third support point. It is also contemplated that there could be more than one telescoping leg to support the frame. The legs may be all on the same side of the frame or on both the proximal and distal ends of the frame.

Lastly, the frame 20 contains securing tabs 62 that are mounted to the frame 20 by screws 63. A piece of glass 60 or metal mesh 61 is fitted to match the shape of the frame 20 is placed into the top of the frame 20 and the securing tabs 62 are placed over the glass 60 and alongside the side of the frame 20 and are screwed into place to prevent the glass 60 from moving.

The rail mounting system 10 can be utilized for supporting various items including glassware, plates, centerpieces, candles etc. The rail mounting system 10 is designed to be easily removed from the railing 80 and stored for future use. The various detent pins 28, 42 and 57 need just be removed and the telescoping leg 50 retracted, and the frame 20 with the glass 60 secured in place can be lifted off the railing 80 and the unit stored for later use.

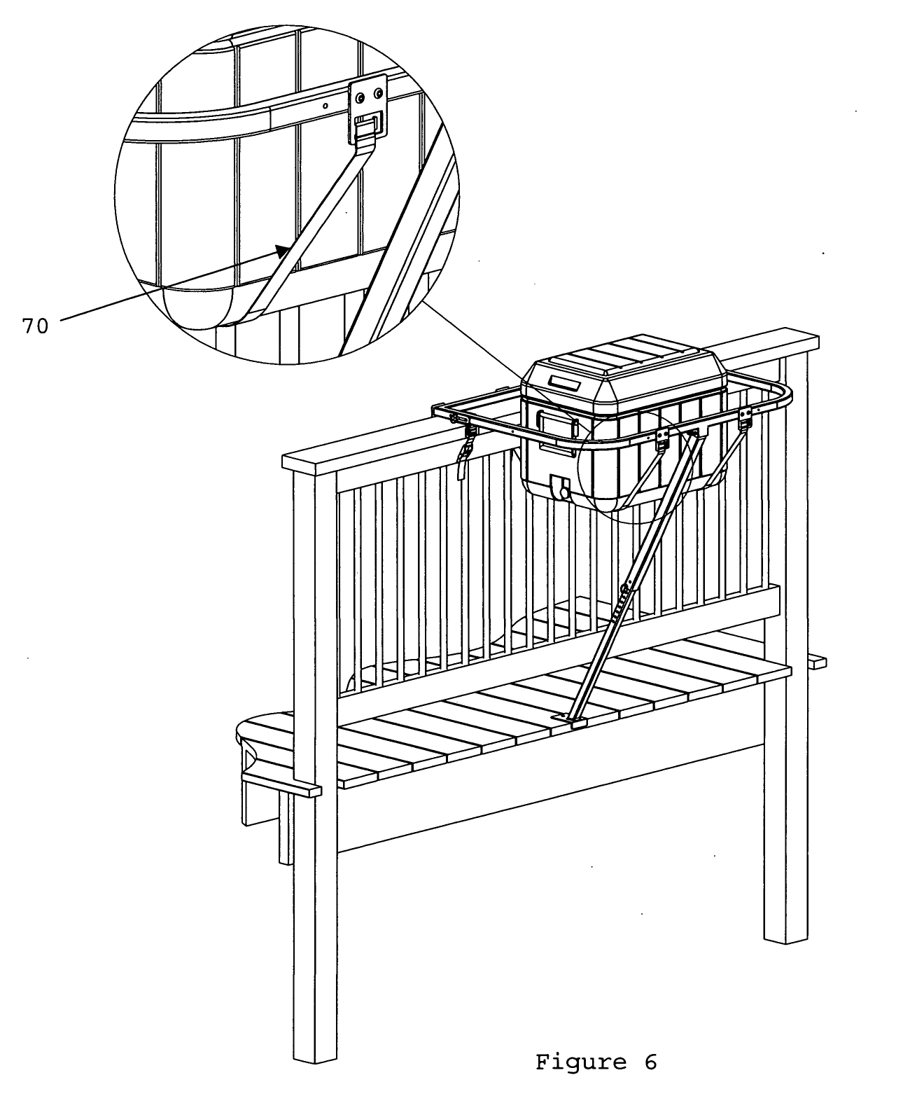

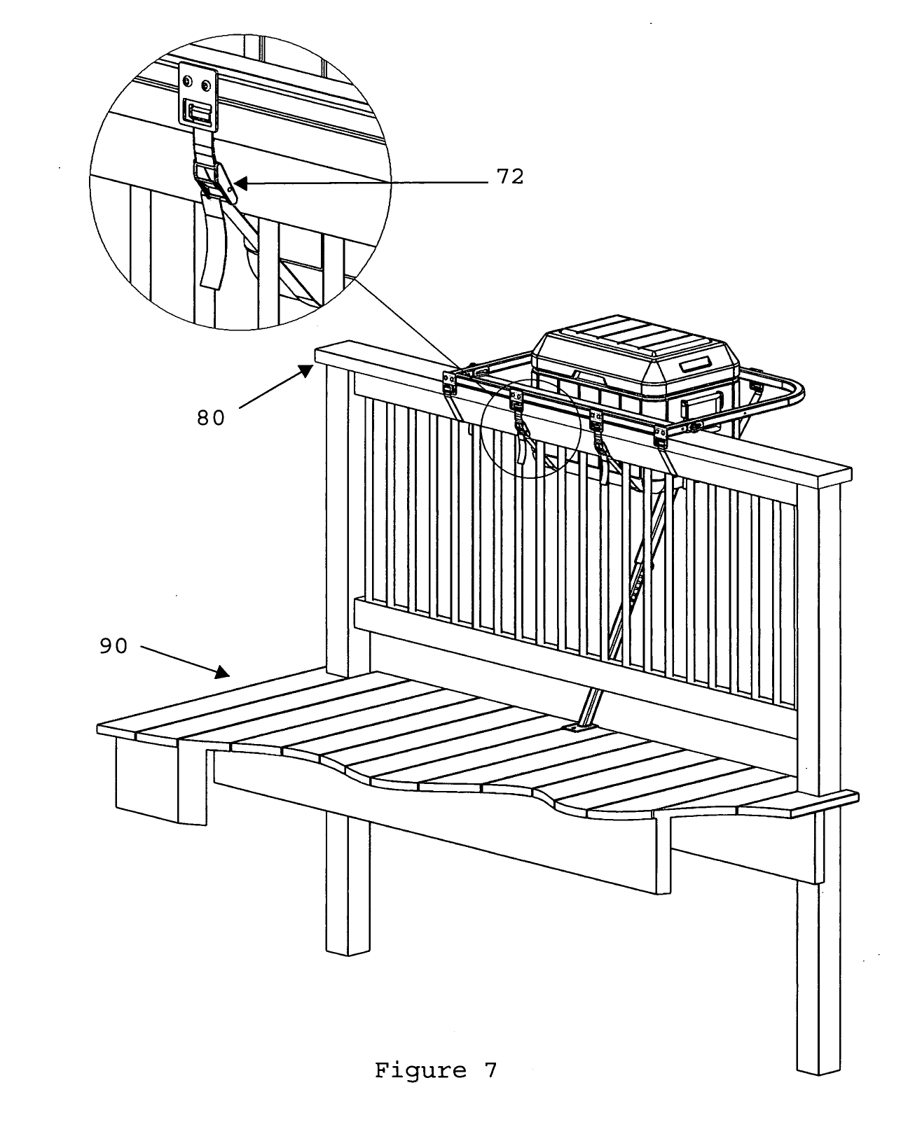

In another embodiment, see FIGS. 6 and 7, the strapping 70, 75 spans from the proximal part of the frame 20 to the distal part of the frame 20 and hangs loosely between the two ends of the frame 20. Next a cooler can be placed through the frame 20 and into contact with the strapping 70, 75 such that the bottom surface of the cooler touches the top surface of the strapping 70, 75 and holds the cooler upright with the additional support of the frame 20.

In another embodiment, the frame and brackets could be formed monolithically.

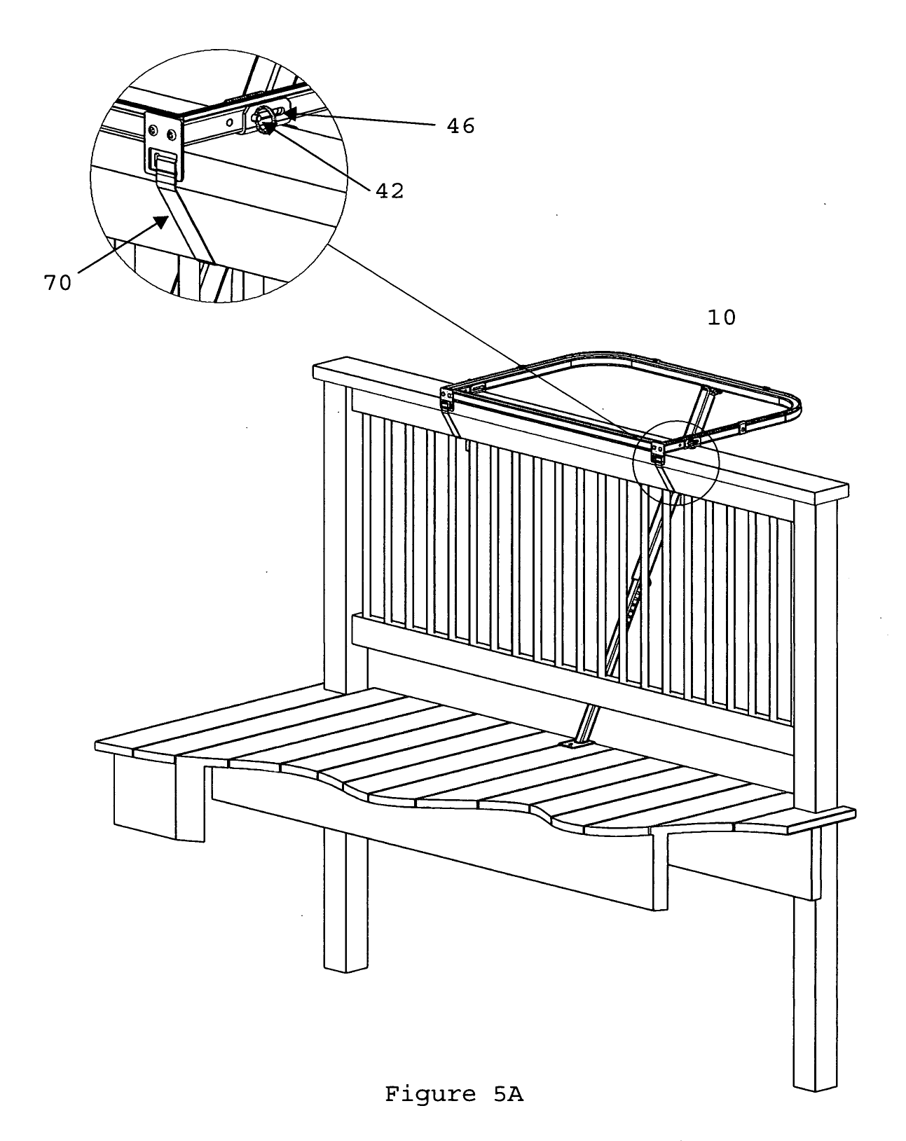

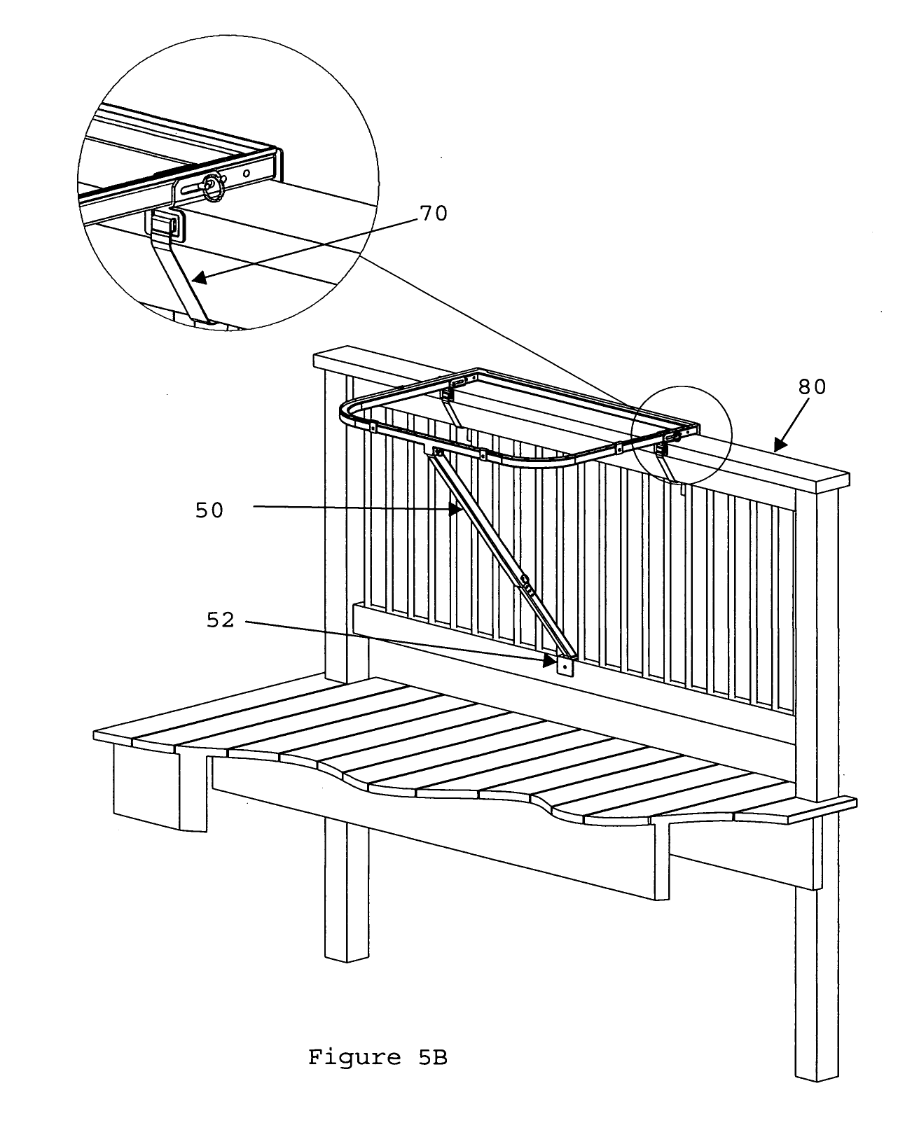

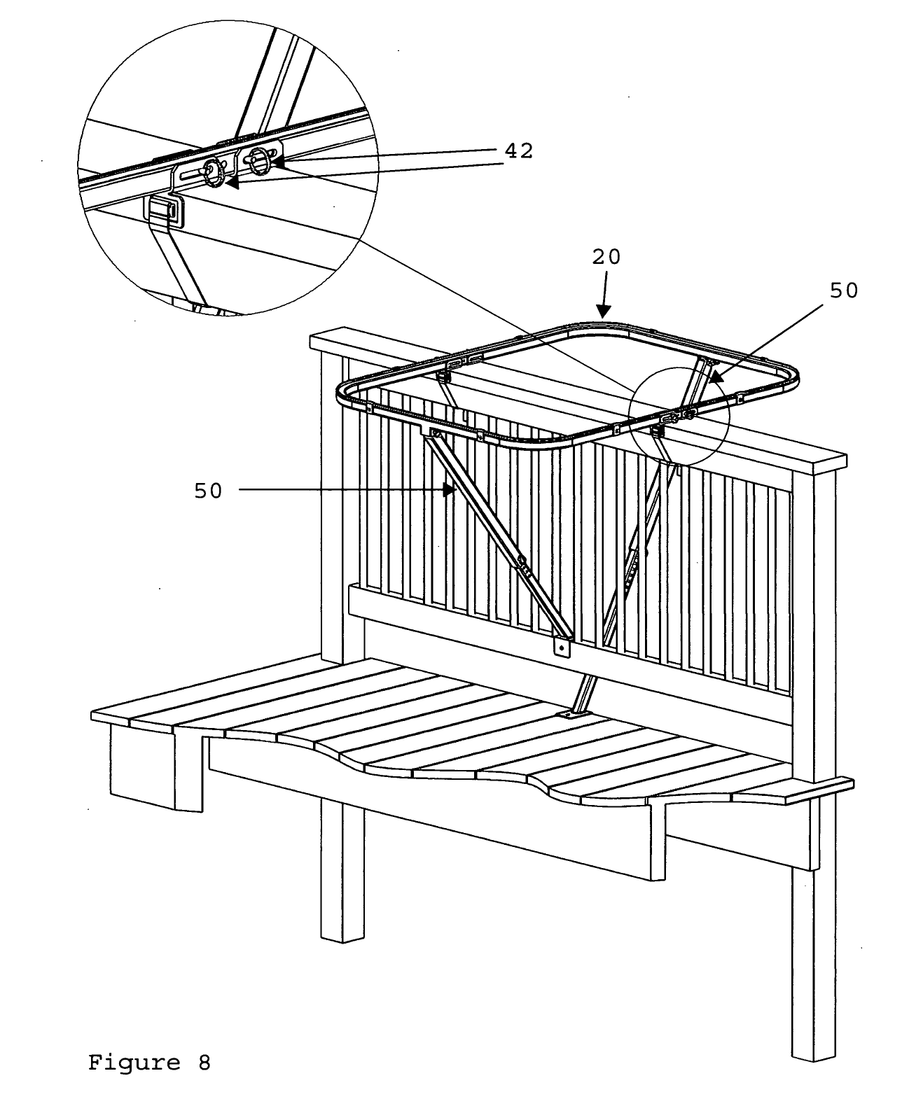

In yet another embodiment, the frame 20 may span both inside and outside the deck, balcony or patio perimeter as noted in FIG. 8. This provides more surface area for containing various items including but not limited to a drop in tray that may contain recesses for holding utensils or for various herbs. This embodiment contains two telescoping arms to provide support on both sides of the railing since the frame spans across both sides of the railing. The telescoping arm that resides inside the railing rests on the bottom horizontal cross member of the railing, as depicted in FIGS. 5B and 8.

In yet another embodiment, the device may be installed such that it is extending inward from the railing as depicted in FIG. 5B, to serve as a table or countertop for instance.

What is claimed is:

1. A system for providing a railing extension device, the system comprising:
a frame member;
an adjustable strap member;
a telescoping leg member;
and at least one U shaped bracket, whereby the U shaped bracket resides between the railing and the frame.

2. The system of claim 1, whereby the adjustable strap member connects to the U shaped bracket.

3. The system of claim 1, wherein weight on the railing extension device may further secure the frame to the railing by locking the U shaped bracket and the adjustable strap member.

4. The system of claim 3, whereby the adjustable strap connects to the frame member by releasably attaching to a second bracket member.

5. The system of claim 1, wherein the telescoping leg member contains a foot portion that is adjustable to accommodate various surfaces.

6. A method for securing a railing extension device comprising:
providing a frame member;
securing the frame member to the railing by use of a strap member;
supporting the frame member with the use of a telescoping member.

7. The method of claim 6, wherein the step of securing the U shaped bracket between the railing and frame further includes the use of a detent pin.

8. The method of claim 6, wherein the strap attaches to a U shaped bracket member.

9. The method according to claim 8, whereby the U shaped member resides between the railing and the frame such that the weight on the frame assembly further secures the frame member to the railing.

10. The method according to claim 7, whereby the detent pin locks the U shaped bracket in relation to the railing.
